(19) United States
(12) Patent Application Publication
(10) Pub. No.: US 2006/0183517 A1
(43) Pub. Date: Aug. 17, 2006

(54) Display rotating and sliding module

(75) Inventor: Li-Yen Wang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/104,430

(22) Filed: Apr. 13, 2005

(30) Foreign Application Priority Data
Feb. 16, 2005 (TW) 94104547

(51) Int. Cl. H04B 1/38; H04M 1/00

(52) U.S. Cl. 455/575.4; 455/566

(57) ABSTRACT

The present invention provides a display rotating and sliding module for a mobile phone. This module includes a sliding mechanism for moving the display to adjust its position and a rotatingal mechanism pivotably connected with the display to adjust the included angle.

### RELATED APPLICATIONS

The present application is based on, and claims priority from, Taiwan Application Serial Number 94104547, filed Feb. 16, 2005, the disclosure of which is hereby incorporated by reference herein in its entirety.

### FIELD OF THE INVENTION

The present invention is related to a rotating and sliding module for a display, and more particularly to a rotating and sliding module for a liquid crystal display installed in a portable device.

### BACKGROUND OF THE INVENTION

Many advantages exist of a liquid crystal display (LCD), such as high display quality, small volume, low weight, low voltage driving, low power consumption, and so on. Therefore, LCDs have been extensively used in various portable electrical devices, such as mobile phones, notebooks and so on.

Typically, the LCD is embedded in a standing type mobile phone shield. Therefore, a user has to move the whole mobile phone to adjust the view angle. At this time, if the user wants to use the mobile phone for a call, he has to cooperate with the keyboard located in an unusual position, which is very inconvenient.

In comparison, the LCD is embedded in a foldable cover for a mobile phone with a foldable cover. When using this type of mobile phone for a call, the cover is first opened to expose the LCD. A rotating mechanism is installed between the cover and the base of the mobile phone for adjusting the opening angle of the cover to change the LCD view angle. However, the LCD of this mobile phone is rotated around a fixed axis. The distance between the LCD and the base is fixed. Therefore, the LCD position has to be considered when using the keyboard. For example, the control key of a typical foldable mobile phone is always located in the position close to the LCD. Therefore, using the control key often obstructs the user from viewing the LCD.

Therefore, it is the goal for a designer to create a mobile phone with an LCD that can be freely adjusted by a user for changing its view angle and location.

### SUMMARY OF THE INVENTION

Therefore, the main purpose of the present invention is to provide a rotating and sliding module used in an operation interface for moving and rotating a display.

The other purpose of the present invention is to provide a rotating and sliding module for adjusting the view angle and the distance of a display.

According to the foregoing purposes, the present invention provides a rotating and sliding module that includes a sliding mechanism for adjusting the distance between the display and the user and a rotating mechanism for adjusting the view angle of the display.

The present invention also provides a mobile phone with an adjustable display. This mobile phone includes a base, a display and a rotating and sliding module. The base and the display are connected together through the rotating and sliding module. The rotating and sliding module includes a sliding mechanism for adjusting the distance between the display and the user and a rotating mechanism for adjusting the view angle of the display.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 is a schematic diagram of a mobile phone with a rotating and sliding module according to a preferred embodiment of the present invention;

FIG. 2 illustrates a cross-sectional view from the A-A line in FIG. 1;

FIGS. 3A to 3C illustrate schematic diagrams of the structure of the area where the rotating apparatus couples with the sliding apparatus;

FIG. 4 illustrates how the display is moved out of the hollow region by the sliding apparatus; and

FIGS. 5A to 5D are the cross-sectional views from the line B-B in FIG. 1.

### DETAILED DESCRIPTION OF THE PREFERRED EMBODIMENT

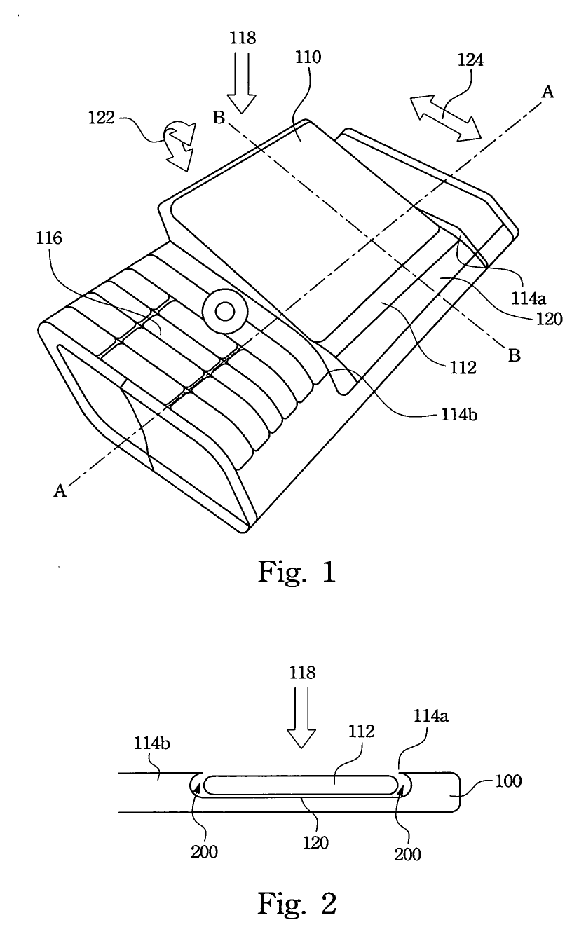

FIG. 1 is a schematic diagram of a mobile phone with a rotating and sliding module according to the preferred embodiment of the present invention. It is noticed that the rotating and sliding module of the present invention also may be used in various portable devices, such as a PDA, notebook and so on. In this figure, the mobile phone 100 includes a keyboard 116, a display 110, a rotating and sliding module that includes a rotating apparatus 112 and sliding apparatuses 114a and 114b. The rotating apparatus 112 may rotate the display 110 from 0 to 180 degrees as indicated by the arrow 122. The sliding apparatus 114a and 114b may move the display 110 along the direction as indicated by the arrow 124.

FIG. 2 illustrates a cross-sectional view from the A-A line in FIG. 1. The display 110 connected to the rotating apparatus 112 is located in a hollow region 118 in the mobile phone 100. The hollow region 118 includes a bottom 120 and two sidewalls connected with the bottom 120. The two sliding apparatuses 114a and 114b are respectively installed in the two sidewalls of the hollow region 118. The two ends of the rotating apparatus 112 are embedded into the two sliding apparatuses 114a and 114b, respectively. The position of the rotating apparatus 112 contacting the sliding apparatus 114a or 114b is the coupling part 200, which serves as the sliding face. The rotating apparatus 112 may move the display 110 along the sliding face.

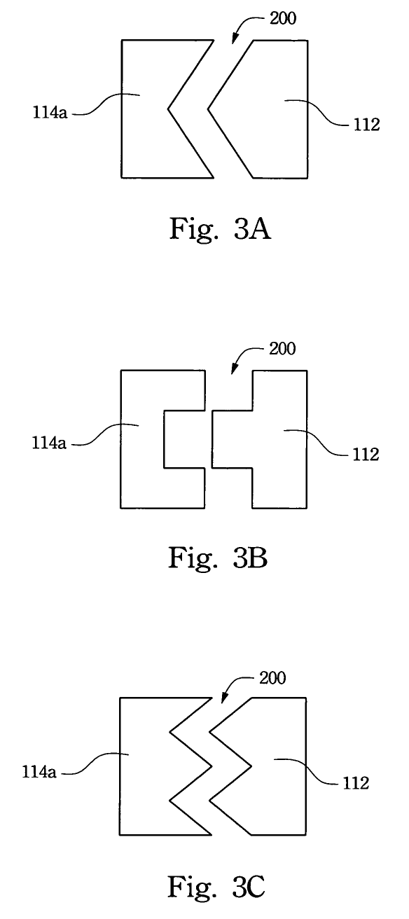

FIGS. 3A to 3C respectively illustrate the structure of the coupling part 200 according to embodiments of the present invention. Although these figures only illustrate the structure between the rotating apparatus 112 and sliding apparatus 114a, the same structure design can be used to couple the rotating apparatus 112 and sliding apparatus 114b. The cross-sectional view of the coupling part 200 is a “V” type in FIG. 3A, a “concave and convex” type in FIG. 3B, and a “W” type in FIG. 3C.

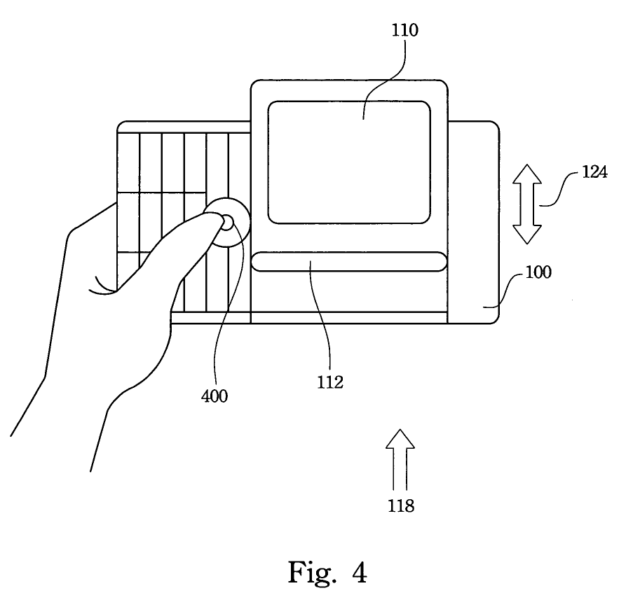

The display 110 is located in the hollow region 118 and remains close to the bottom 120. When a user wants to adjust the viewing angle of the display, he can follow the direction indicated by the arrow 122 (shown in FIG. 1) to open the display 110 to an angle within the range from 0 to 180 degrees through the rotating and sliding apparatus 112. When the display 110 is rotated 180 degrees, the user may watch the information shown in the display 110 from the back of the mobile phone 100. Additionally, the rotating apparatus 112 may move the display 110 along the sliding apparatuses 114a and 114b while the display 110 is rotating. FIG. 4 illustrates the display 110 when it is moved out of the hollow region 118 by the sliding apparatuses 114a and 114b. In other words, when the mobile phone 100 is used to serve as a game console, the user can follow the direction indicated by the arrow 124 to adjust the location of the display 110 to avoid obstructing the user view due to using the control key 400.

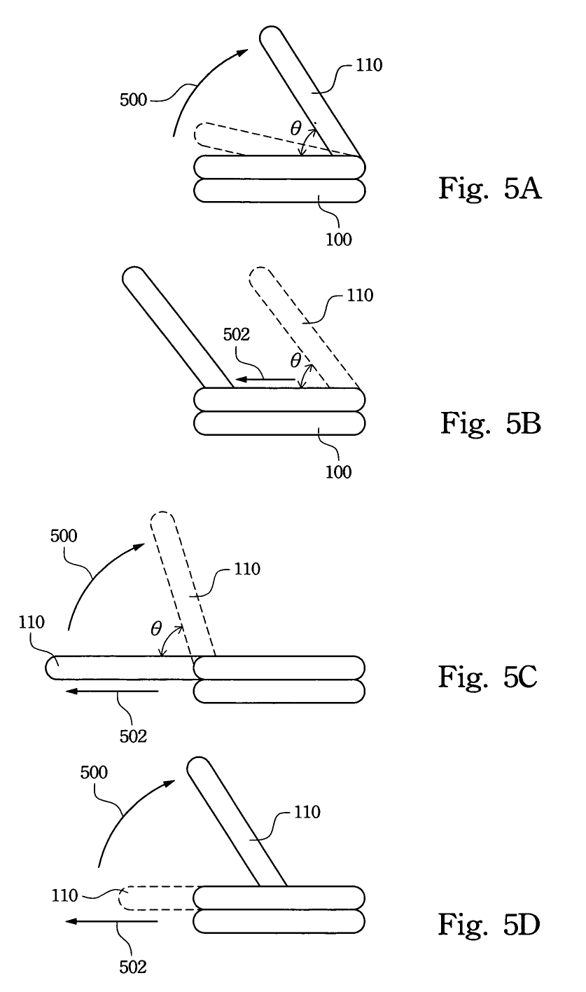

FIGS. 5A to 5D illustrate the cross-sectional views from the B-B line in FIG. 1. These figures illustrate various methods to adjust the viewing angle of the display 110 of the mobile phone 100. However, other adjusting methods can be used in the preset invention.

In FIG. 5A, following the direction of the arrow 500, the display 110 is rotated by the rotating apparatus 112 as shown in the FIG. 4. The included angle θ can be adjusted by the rotating apparatus 112 according to the user preference. Moreover, if the user thinks the display 110 too close, following the direction of the arrow 502 in FIG. 5B, the display 110 is moved by the sliding apparatuses 114a and 114b to change the distance from the user. Conversely, the display 110 can be moved first, following the direction of the arrow 502, by the sliding apparatuses 114a and 114b to change its distance; then, the included angle θ can be changed by following the direction of the arrow 500 references to FIGS. 5C and 5D.

Accordingly, the rotating and sliding module of the present invention may completely adjust not only the location but also the viewing angle. This module includes a rotating apparatus to adjust the viewing angle and a sliding apparatus to adjust the location of the display. Therefore, the user may dynamically change its viewing angle and location according to his preference.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A display rotating and sliding module used in an operation interface, said module comprising:
a rotating apparatus coupling with a display for rotating said display a angle comparing with said operation interface; and
a sliding apparatus coupling with said rotating apparatus for sliding said display along said sliding apparatus.

2. The display rotating and sliding module of claim 1, wherein said sliding apparatus and said rotating apparatus have a “V” type, “concave and convex” type or “W” type coupling structure.

3. The display rotating and sliding module of claim 1, further comprising a sliding face that is the coupling area of said sliding apparatus and said rotating apparatus for providing said rotating apparatus sliding.

4. The display rotating and sliding module of claim 1, wherein said rotating apparatus may rotate the display from 0 to 180 degrees.

5. A display rotating and sliding module used in a mobile phone, said module comprising:
a rotateing apparatus coupling with a display for rotating said display around said mobile phone; and
a first and second sliding apparatus installed in said mobile phone, wherein the two ends of said rotating apparatus are respectively coupled to said first and second sliding apparatus for sliding said display along said first and second sliding apparatus.

6. The display rotating and sliding module of claim 5, wherein said sliding apparatuses and said rotating apparatus have a “V” type, “concave and convex” type or “W” type coupling structure.

7. The display rotating and sliding module of claim 5, further comprising two sliding faces that are the coupling areas of said sliding apparatuses and said rotating apparatus for providing said rotating apparatus sliding.

8. The display rotating and sliding module of claim 5, wherein said rotating apparatus may rotate the display from 0 to 180 degrees.

9. A portable device, said device comprising:
a display;
a base; and
a rotating and sliding module connected to said display and said base, wherein said module further comprises:
a rotating apparatus coupling with said display for rotating said display around said base; and
a first and second sliding apparatus installed in said base, wherein the two ends of said rotating apparatus are respectively coupled to said first and second sliding apparatus for sliding said display along said first and second sliding apparatus.

10. The portable device of claim 9, wherein said sliding apparatuses and said rotating apparatus have a “V” type, “concave and convex” type or “W” type coupling structure.

11. The portable device of claim 9, further comprising two sliding faces that are the coupling areas of said sliding apparatuses and said rotating apparatus for providing said rotating apparatus sliding.

12. The portable deice of claim 9, wherein said rotating apparatus may rotate the display from 0 to 180 degrees.
